(19) United States
(12) Patent Application Publication
(10) Pub. No.: US 2006/0260473 A1
(43) Pub. Date: Nov. 23, 2006

(54) Insulated platter

(76) Inventors: Keith Nybakke, Minneapolis, MN (US); James Cabak, Plymouth, MN (US)

Correspondence Address: Leffert Jay & Polglaze, P.A., P.O. Box 581009, Minneapolis, MN, 55458-1009, US

(21) Appl. No.: 11/132,638

(22) Filed: May 19, 2005

(51) Int. Cl. A47J 37/10

(52) U.S. Cl. 99/422

(57) ABSTRACT

An insulated platter is disclosed herein. The insulated platter has a depression for receiving a heated pan in an upper surface thereof. In one embodiment, platter includes one or more ridges formed around the depression that extend upwardly above the edges of the heated pan to prevent contact with the pan. The platter also has an insulating layer applied to a lower surface thereof to limit heat transfer from the heated pan to a surface on which the platter rests.

### TECHNICAL FIELD

The present invention relates to insulated serving platters and the like.

### BACKGROUND

Serving meals in a hot skillet has become more and more popular in the restaurant industry. Such service is considered aesthetically pleasing and also serves to keep the food warm as the hot skillet retains heat longer than does a normal plate or platter. One type of food commonly served in this manner is fajitas. Fajitas are grilled strips of meat, typically steak or chicken, served with grilled vegetables. The fajitas are typically wrapped in a tortilla prior to being eaten. Fajita service generally uses a cast iron skillet with a handle that is similar to a typical cast iron frying pan. Generally, the skillet is heated to about 500° F. (sometimes hotter), before use. To prevent burns and scorching, the hot skillet is inserted into a carrier, typically made of plywood, and the fajita ingredients are placed on the skillet. A miniature oven mitt is commonly placed over the handle of the skillet. As soon as the fajita service is assembled, the server immediately brings the fajitas to the table, leaving a trail of flavorful “smoke” through the dining room.

There are several problems inherent in this type of hot skillet service. A first problem relates to the scorching of the plywood holder. After a few uses, the plywood holder usually has a layer of charcoal on it, which often becomes soaked with grease and cooking juices. The plywood holders, when in this inevitable condition, are not very appetizing to look at and can also smell bad. As a result, in some locales, the health department requires that the plywood holders pass through the dishwasher after each use. The plywood holders naturally begin to delaminate when treated this manner. In some instances, the typical life span of a plywood holder is about 30 days.

A second problem with plywood holders is their poor insulating characteristics. The thickness of the plywood between the hot cast iron skillet and a tabletop is often less than ⅜″. This amount of plywood provides almost no thermal protection to a tabletop. In some instances, the bottom of a plywood holder can reach more than 150° F. in less than a minute after a hot skillet is placed thereon. This high heat will readily damage the finish on tables.

A third problem with the typical plywood holder is that the hot sides of the cast iron skillet are exposed to the customer. Even though the patron is told the skillet is very hot, it is still common for a patron to get a mild burn from the cast iron. The danger of burns is even more serious for the servers that bring the fajita service to a table.

Accordingly, there is a need for an insulated platter or trivet that is aesthetically pleasing, able to prevent inadvertent burns to a server or diner, that is resistant to scorching and which does not readily conduct heat to a table or counter top. These and other objects, aspects, features and advantages of the present invention will become more fully apparent upon careful consideration of the following Detailed Description of the Invention and the accompanying Drawings, which may be disproportionate for ease of understanding, wherein like structure and steps are referenced generally by corresponding numerals and indicators.

### DESCRIPTION OF THE DRAWINGS

FIG. 1 is a top, perspective view of one embodiment of a platter of the present invention.

FIG. 2 is a cross-sectional perspective view of the embodiment of the platter of FIG. 1 taken along cutting lines 2-2.

FIG. 3 is a perspective view of an embodiment of a platter in relation to a skillet.

### DETAILED DESCRIPTION

In the following detailed description of the invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

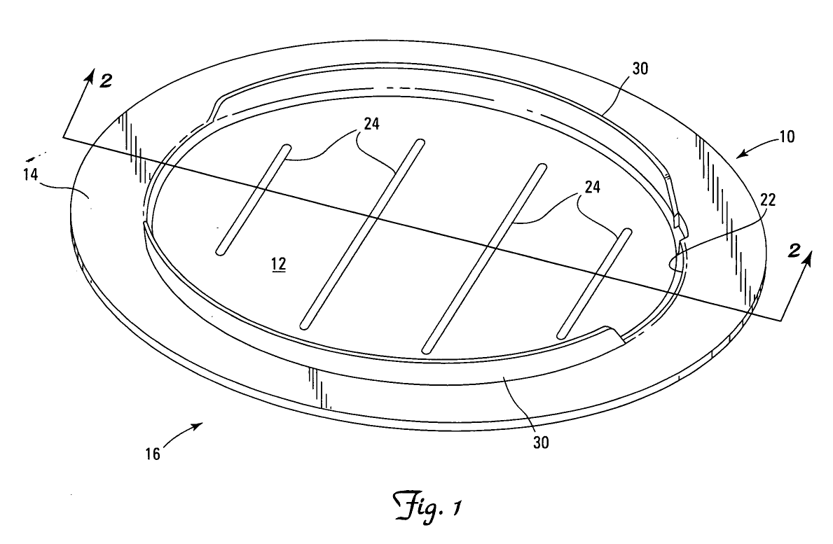

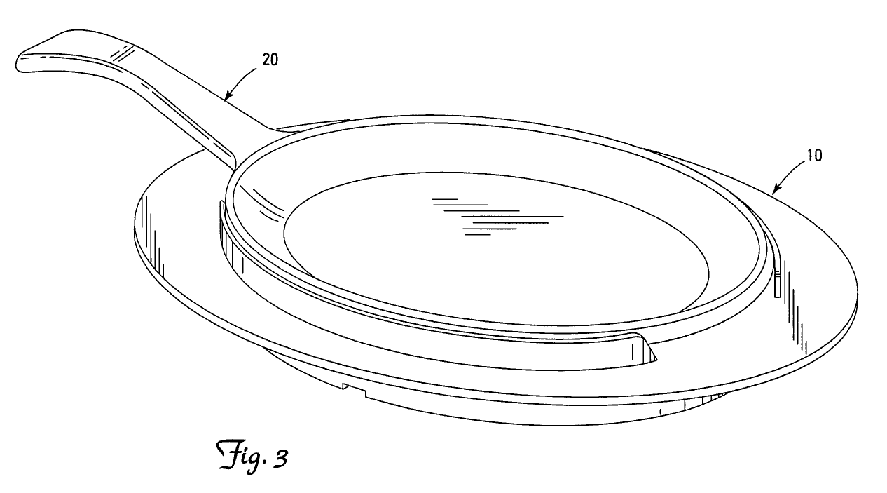

The platter 10 includes a base 12 that has an upper surface 14 and a lower surface 16. The upper surface 14 of the platter 10, as best seen in FIG. 1, is adapted to cradle a pan 20 such as a skillet as seen in FIG. 3. The lower surface 11 of the base 12 is adapted to support the platter 10 on a surface 11 such as a table or counter in such a manner as to minimize heat transfer from the platter to the surface 11.

The upper surface 14 includes a depression 22 formed thereinto, which has a shape that is at least partially conformed to the shape of the underside of a skillet 20 that is placed thereon. In order to limit heat transfer between the skillet 20 and the platter 10, the depression 22 may include a number of stand offs 24, in this case a plurality of ribs, that limit the surface 11 area contact between the skillet 20 and the platter 10, thereby limiting conductive heat transfer therebetween.

To protect a server or a patron from burning themselves on the edges of a skillet 20, ridges 30 extend around at least a portion of a periphery of the depression 22 and in some embodiments, around the entire periphery thereof. The ridges 30 extend upwardly away from the upper surface 14 of the base 12 to a height greater than that of the edges of a skillet 20 that is resting on the upper surface 14 of the base 12. In some embodiments, the ridges 30 are relatively low and unobtrusive in that they do not extend very high above the upper surface 14 of the base 12. In these embodiments, the depression 22 has a depth that extends sufficiently into the base 12 to permit the ridges 30 to extend above the edges of a skillet 20 placed on the platter. In other embodiments, a relatively shallow depression in the platter 10 requires relatively higher ridges 30 to protect a patron or server from burning themselves on the edges of the skillet 20.

In some embodiments, the lower surface 16 of the base 12 will include a standoff 32 that raises the body 12 of the platter 10 above a surface 11 on which it rests. In some embodiments, the standoff 32 may be a continuous ridge, a discontinuous ridge or a plurality of legs that raise the base 12 above the surface 11 on which the platter 10 rests. The inclusion of a continuous ridge, a discontinuous ridge, or legs on the lower surface 16 of the base serves to limit the area of direct contact between the platter 10 and the surface 11 on which it rests, thereby limiting conductive heat transfer therebetween.

While reducing the surface area of contact between the skillet 20 and the platter 10 and between the platter 10 and a surface 11 on which it rests may limit conductive heat transfer between the skillet 20 and the surface 11, thereby preventing damage to the surface 11, there remains the issue of radiant and convective heat transfer. Both radiant and convective heat transfer between the skillet 20 and the surface 11 are directly related to the temperature of the surface from which heat is being transferred. Accordingly, by reducing the temperature of the lower surface 16 of the base 12, it will be possible to further limit heat transfer from the platter 10 to the surface 11. In one embodiment, the lower surface 16 of the base 12 is insulated to maintain a lower temperature opposite the surface 11.

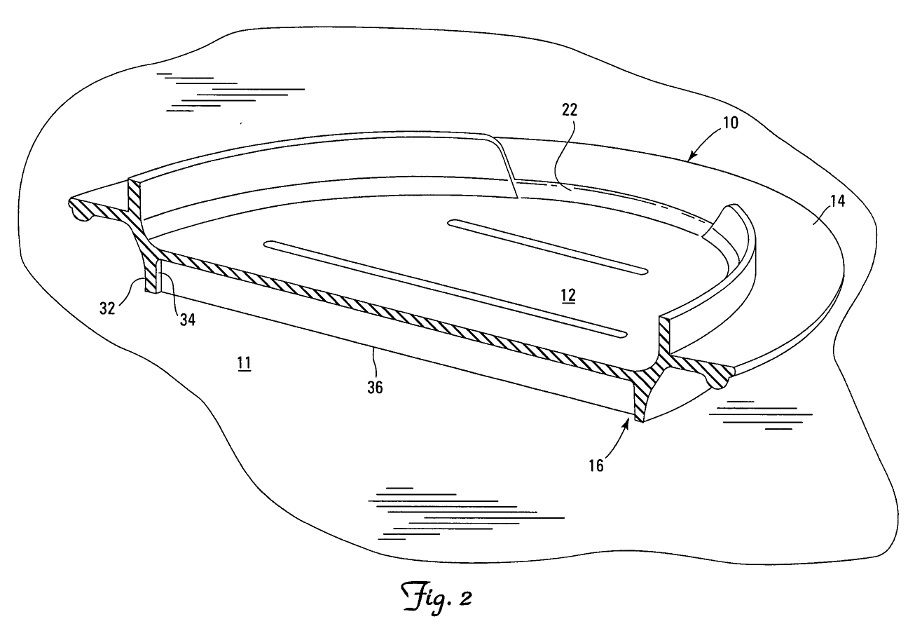

As can be seen in FIG. 2, the lower surface 16 of the base 12 is in one embodiment provided with a depression 34 that extends into the lower surface 16 of the base 12. This depression 34 is filled with an insulating material 36 that prevents or curtails the conductive transfer of heat energy from the upper surface 14 of the base to the lower surface 16 of the base in a manner that limits radiant and convective heat transfer from the lower surface 16 to the surface 11.

In another embodiment, the a layer of insulating material 36 is laminated to the lower surface 16 of the base 12 to limit the conduction of heat from the upper surface 14 of the base 12 to the surface 11 upon which the platter rests. In this embodiment, the ridge or legs 32 are formed into the insulating material 36.

It is desirable to form the base 12 of the platter 10 from a durable material such as a glass filled polyester resin or a nylon that is heat, chemical and water resistant. Furthermore, it is desirable to use a material that is substantially colorfast when subjected to high temperatures and repeated washings. The base 12 is typically formed by compression molding, injection molding, and/or stamping, though it is to be understood that the platter base 12 may be cast and/or machined as well. Where provided, the insulating material 36 is adhered with an adhesive, compression molded, poured and cured or insert molded into the depression 34 in the lower surface 16 of the base 12. In one embodiment, the base 12 is formed of a solid polyester thermoset resin and the insulating material 36 is formed of the same polyester thermoset resin that is mixed with gas-filled spheres that provide a strong insulative effect. This material is available from BMC of Chicago, Ill. The benefit to using the same polyester thermoset resin in both the base 12 and the insulating material 36 is that there is as strong cohesive bond formed therebetween. In this embodiment, the insulating material 36 has a low specific heat (in one embodiment approximately 1.16 Joule/gram-deg. Kelvin). Accordingly, even where the temperature of the insulating material 36 is elevated to undesirable levels, because of the low specific heat of the insulating material 36, heat will be transferred at a very slow rate that will permit the objects in contact with or immediately adjacent to the insulating material not to absorb excessive amounts of heat.

In use a heated skillet 20 is placed in the depression 22 in the upper surface 14 of the platter 10 and the desired foodstuffs are placed into the skillet 20. A server or waitperson will preferably place the platter 10, bearing the skillet 20 and foodstuffs, on a tray or the like and will transport the platter 10 to the table 11 where the server places the platter 10 before a patron. Alternatively, because of the insulating properties of the insulating materials 36, a server may be able to carry the platter 10 bearing a heated skillet and foodstuffs directly in his or her hand, though safety concerns argue for the use of a tray in transporting the platter 10 when a heated skillet 20 is placed thereon.

The insulating material has a very low density, approximately 0.4-0.5 grams/cc. The insulating material also has a very low specific heat and lower thermal conductivity. The thermal conductivity is approximately 0.123 Watts/meter-deg. Kelvin. The specific heat is approximately 1.16 Joule/gram-deg. Kelvin. Low density, low specific heat material simply does not store much heat. This reduces the potential damage to table tops, and reduces burns to servers and patrons.

### CONCLUSION

Although specific embodiments of an insulative platter have been illustrated and described herein, it is manifestly intended that this invention be limited only by the following claims and equivalents thereof.

What is claimed is:

1. An insulative platter comprising a first layer and a second layer, the first layer having an upper surface with a registration structure formed therein for receiving a heated pan, the second layer being below the first layer such that the second layer faces a surface on which the platter rests, the second layer being formed of an insulative material that limits heat transfer from the first layer to the surface on which the platter rests.

2. The insulative platter of claim 1 further comprising at least one ridge secured to the upper surface of the first layer at least partially around the periphery of the registration structure.

3. The insulative platter of claim 1 further comprising at least one stand off structure formed on a bottom surface of the registration structure such that a heated pan resting on the platter is supported by the at least one standoff structure.

4. The insulative platter of claim 1 further comprising at least one second standoff structure formed on a lower surface of the insulative platter, the at least one second standoff structure supporting the first and second layers of the insulative platter above a surface on which the platter rests.

5. The insulative platter of claim 4 wherein the at least one second standoff structure comprises a structure chosen from a list consisting of a peripheral ridge extending downward from the insulative platter, a discontinuous peripheral ridge extending downward from the insulative platter, and a plurality of legs extending downward from the insulative platter.

6. The insulative platter of claim 4 wherein the at least one second standoff structure is formed as part of the first layer of the insulative platter.

7. The insulative platter of claim 4 wherein the at least one second standoff structure is formed as part of the second layer of the insulative platter.

8. The insulative platter of claim 1 wherein the second layer comprises a polyester thermoset resin.

9. The insulative platter of claim 8 wherein the polyester thermoset resin further comprises a quantity of gas filled spheres.

10. The insulative platter of claim wherein the insulative material has a low specific heat of approximately 1.16 Joule/gram-deg. Kelvin.

11. A method of forming an insulated platter for supporting a heated pan comprising:
molding a first layer having an upper surface and a lower surface, the upper surface of the first layer having a registration depression formed therein; and,
attaching a second layer to the lower surface of the first layer, the second layer comprising a polyester thermoset resin compounded with gas-filled spheres.

12. The method of forming an insulated platter for supporting a heated pan of claim 11 further comprising attaching the second layer to the lower surface of the first layer by compression molding the second layer to the first layer.

13. The method of forming an insulated platter for supporting a heated pan of claim 11 wherein the upper surface of the first layer further comprises at least one ridge formed around the periphery of the registration depression, the at least on ridge being sufficiently tall to extend above an upper edge of a heated pan engaged by the registration depression.

14. The method of forming an insulated platter for supporting a heated pan of claim 11 wherein the registration depression has formed into a bottom surface thereof at least one standoff structure.

15. The method of forming an insulated platter for supporting a heated pan of claim 11 wherein the first layer has extending downwardly therefrom at least one second standoff structure, the at least one second standoff structure being adapted to support the insulated platter above a surface.

16. An insulated platter comprising:
a base, the base having an upper surface with a depression for receiving a heated pan formed therein, the depression having at least one ridges formed in a bottom surface thereof to prevent full facial contact between the platter and a heated pan, the depression having a protective ridge formed round at least a portion of its periphery, the protective ridge extending above an upper edge of a heated pan when the heated pan is received in the depression of the base; and,
a bottom secured to a lower surface of the base, the bottom being formed of an insulative material that limits heat transfer from the base to a surface on which the platter rests.

17. The insulated platter of claim 16 further comprising at least one standoff formed as part of the base of the insulated platter.

18. The insulated platter of claim 16 further comprising at least one standoff formed as part of the bottom of the insulated platter.

19. The insulated platter of claim 16 wherein the bottom comprises a polyester thermoset resin.

20. The insulated platter of claim 19 wherein the polyester thermoset resin further comprises a quantity of gas filled spheres.

21. The insulated platter of claim 16 wherein the bottom has a specific heat of approximately 1.16 Joule/gram-deg. Kelvin.
